(19) United States
(12) Patent Application Publication
(10) Pub. No.: US 2013/0254601 A1
(43) Pub. Date: Sep. 26, 2013

(54) DEBUGGING DEVICE

(71) Applicants: Hong Fu Jin Precision Industry (ShenZhen) Co., Ltd., (US); Hon Hai Precision Industry Co., Ltd., (US)

(72) Inventors: XIAO-GANG YIN, Shenzhen (CN); GUO-YI CHEN, Shenzhen (CN)

(73) Assignees: HON HAI PRECISION INDUSTRY CO., LTD., New Taipei (TW); Hong Fu Jin Precision Industry (ShenZhen) Co., Ltd., Shenzhen (CN)

(21) Appl. No.: 13/721,075

(22) Filed: Dec. 20, 2012

(30) Foreign Application Priority Data
Mar. 22, 2012 (CN) 201210077820.1

(51) Int. Cl. G06F 11/32

(52) U.S. Cl. CPC G06F 11/325
USPC 714/57

(57) ABSTRACT

A debugging device for a terminal electronic device includes a first connector, a second connector, a processor, and a display unit. The first connector is coupled to the terminal electronic device to receive power on self test (POST) codes. The second connector is coupled to the terminal electronic device. The processor converts the received POST codes into malfunction-indicator codes, and stores the malfunction-indicator codes. The malfunction-indicator codes are displayed on the display unit, and can be transmitted to the terminal electronic device via the second connector.

### BACKGROUND

1. Technical Field

The disclosure generally relates to debugging devices, and particularly to a device for debugging a terminal electronic device.

2. Description of the Related Art

A debugging card is used to debug a terminal electronic device such as a personal computer. After the terminal electronic device is powered on, a process of power on self test (POST) is initiated, and a basic input/output system (BIOS) of the terminal electronic device outputs POST codes to the debugging card. However, the POST codes are displayed only momentarily on a display unit of the debugging card. If the BIOS outputs a plurality of POST codes, confusion may occur regarding results of the debugging.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic view of a debugging device, according to an exemplary embodiment.

FIG. 2 is a block diagram illustrating of the debugging device as shown in FIG. 1.

### DETAILED DESCRIPTION

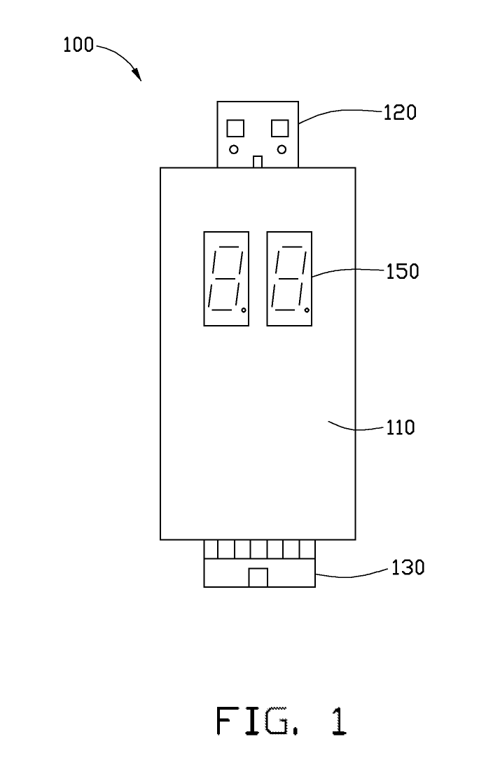

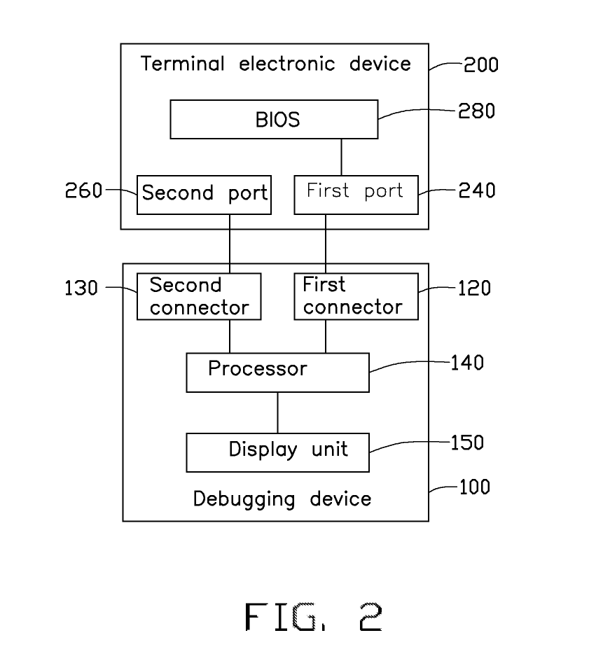

FIGS. 1-2 show a debugging device 100 of one embodiment. The debugging device 100 can be used to debug a terminal electronic device 200 (e.g., a personal computer or a server) to store and display power on self test (POST) codes output from the terminal electronic device 200.

The terminal electronic device 200 includes a first port 240, a second port 260, a basic input/output system (BIOS) 280, and other electronic components (not shown), such as a hard disk drive (HDD), a keyboard, a central processing unit (CPU), or an audio assembly, for example.

In one exemplary embodiment, the first port 240 can be a peripheral component interconnect (PCI) port or an industry standard architecture (ISA) port, and the second port 260 is a universal serial bus (USB) port. The BIOS 280 outputs the POST codes via the first port 240 when any electronic component of the terminal electronic device 200 malfunctions or fails to be powered on. In one exemplary embodiment, the POST codes are in a form of binary numbers.

The debugging device 100 includes a body 110, a first connector 120, a second connector 130, a processor 140, and a display unit 150. The first connector 120 and the second connector 130 are positioned at opposite ends of the body 110. The processor 140 is received and integrated in the body 110, and the display unit 150 is exposed on an external surface of the body 110.

In one exemplary embodiment, the first connector 120 is an universal connector of a common debugging card, such as a PCI connector or an ISA connector, and is configured to couple to the first port 240 to receive the POST codes.

In one exemplary embodiment, the second connector 130 is a USB connector, and is configured to couple to the second port 260 of the terminal electronic device 200. Thus, the debugging device 100 can communicate with the terminal electronic device 200 via USB protocols.

The processor 140 is electronically connected between the first connector 120 and the second connector 130. The processor 140 obtains the POST codes from the first connector 120, and converts the POST codes into malfunction-indicator codes in a form of hexadecimal number. Additionally, the processor 140 automatically stores the malfunction-indicator codes, and the malfunction-indicator codes can be output via the second connector 130. Moreover, the processor 140 is electronically connected to the display unit 150 to transmit the malfunction-indicator codes to display unit 150. In one exemplary embodiment, the display unit 150 is two seven-segment Nixie tubes for displaying the malfunction-indicator codes.

When the terminal electronic device 200 is powered on, a process of power on self test (POST) is initiated by the BIOS 280. For example, if the CPU of the terminal electronic device 200 fails to be powered on, the BIOS 280 outputs a POST code “11101110” to the debugging device 100 via the first port 240. If the keyboard of the terminal electronic device 200 malfunctions, the BIOS 280 outputs a POST code “01110110” to the debugging device 100. The debugging device 100 obtains the POST codes “11101110” and “01110110”, and converts the POST code “11101110” to a malfunction-indicator code “EE”, converts the POST code “01110110” to a malfunction-indicator code “76”. Then, the malfunction-indicator codes “EE” and “76” are displayed in turn through the display unit 150. In addition, the malfunction-indicator codes “EE” and “76” are stored in the processor 140 and can be transmitted to the terminal electronic device 200 via the second connector 130. Thus, a display apparatus (not shown) of the terminal electronic device 200 can be utilized for viewing of all the malfunction-indicator codes.

In other exemplary embodiments, the debugging device 100 receives data from the terminal electronic device 200 via the second connector 130, and the data is stored in the processor 140, or other storage with larger capacity.

The debugging device 100 shows the malfunction-indicator codes one at a time through the display unit 150, and also stores the malfunction-indicator codes through the processor 140, for subsequent and repeated viewing as required. Thus, the malfunction-indicator codes serve as a back-up, and can be transmitted in their entirety to other display apparatus for simultaneous display. Therefore, confusion as to the precise test results are reduced, and the debugging device 100 is both efficient and convenient.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A debugging device for a terminal electronic device, the debugging device comprising:
a first connector configured to couple to the terminal electronic device to receive power on self test (POST) codes;
a processor electronically connected to the first connector, the processor converting the POST codes into malfunction-indicator codes, and storing the malfunction-indicator codes;
a display unit electronically connected to the processor, and displaying the malfunction-indicator codes; and
a second connector electronically connected to the processor, and configured to couple to the terminal electronic device to transmit the malfunction-indicator codes to the terminal electronic device.

2. The debugging device as claimed in claim 1, further comprising a body, wherein the first connector and the second connector are respectively positioned at two opposite ends of the body.

3. The debugging device as claimed in claim 2, wherein the processor is received and integrated in the body.

4. The debugging device as claimed in claim 2, wherein the display unit is exposed on the body.

5. The debugging device as claimed in claim 2, wherein the display unit is two seven-segment Nixie tubes.

6. The debugging device as claimed in claim 1, wherein the first connector is a peripheral component interconnect (PCI) connector or an industry standard architecture (ISA) connector.

7. The debugging device as claimed in claim 1, wherein the second connector is a universal serial bus (USB) connector.

8. A debugging device in communication with a terminal electronic device, the debugging device comprising:
a first connector configured to couple to the terminal electronic device to receive power on self test (POST) codes;
a second connector configured to couple to the terminal electronic device; and
a processor electronically connected between the first connector and the second connector;
wherein the processor converts the POST codes into malfunction-indicator codes, the processor stores the malfunction-indicator codes, and transmits the malfunction-indicator codes to the terminal electronic device via the second connector.

9. The debugging device as claimed in claim 8, further comprising a displaying unit electronically connected to the processor, wherein the malfunction-indicator codes are displayed on the displaying unit.

10. The debugging device as claimed in claim 8, further comprising a body, wherein the first connector and the second connector are respectively positioned at two opposite ends of the body.
